(19) United States
(12) Patent Application Publication
(10) Pub. No.: US 2018/0029913 A1
(43) Pub. Date: Feb. 1, 2018

(54) WATER QUALITY OPTIMIZATION SYSTEM

(71) Applicant: TAT-YUNG NG, NORTH POINT (HK)

(72) Inventor: TAT-YUNG NG, NORTH POINT (HK)

(21) Appl. No.: 15/609,468

(22) Filed: May 31, 2017

(30) Foreign Application Priority Data
Jul. 26, 2016 (CN) 201620795567.7

(51) Int. Cl. C02F 9/00; B01D 61/02

(52) U.S. Cl. CPC C02F 9/00; B01D 61/025; C02F 2209/06; C02F 1/66

(57) ABSTRACT

Disclosed is a water quality optimization system comprising a water pump, a water purification device, a water storage device, a controller, a power source and a pH value regulation device, wherein an inlet and an outlet of the water pump are connected with a water source and the pH value regulation device correspondingly; the pH value regulation device is connected with the water storage device through the water purification device; the water storage device is connected with a system outlet and the inlet of the water pump through valves, and comprises a pH value detector with the signal output end connected with the controller; and the control ends of the valves and a water pump driving circuit are connected with the controller. The water quality optimization system can further optimize pure water obtained through air purification and condensation to make the pure water reach the standard of high-quality drinking water.

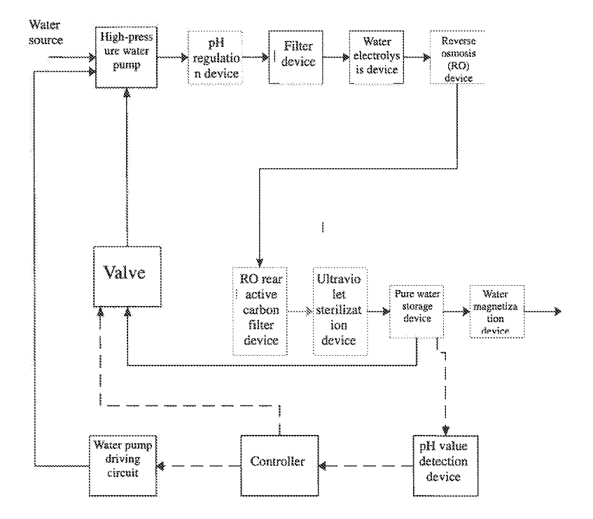

### BACKGROUND OF THE INVENTION

### Technical Field

This invention relates to water treatment equipment, in particular to a water quality optimization system.

### 2. Description of Related Art

Existing fresh water resources which can be easily utilized by humans are mainly from rivers, lakes and shallow groundwater; fresh water resources are deficient due to large consumption, and clean water resources in places with abundant electricity and energy are also relatively deficient and need to be saved and protected due to serious pollution and extremely imbalanced regional distribution; water resources have already been precious resources for humans, and water resource problems have even become a major strategy concerning sustainable development of the national economy and society, and lasting political stability.

In certain remote arid and distressed areas where clean water resources are extremely difficult to obtain and water resource shortages exist, it is hard to lay long delivery pipelines for long-distance supply of drinking water, or to transport drinking water back and forth through transportation facilities without considering transportation costs, or to mount large water quality optimization systems, and consequentially, the cost of safe drinking water becomes extremely high; besides the high drinking water cost, water quality changes or secondary pollution can be caused by long-distance delivery or transportation, and consequentially, water cannot be directly drunk by people safely.

Although the personal demand for drinking water of people in daily life is not large, the requirements for the sanitation, cleanliness, sterility and non-toxicity of the drinking water are high; drinkable pure water can be obtained through air purification and condensation, however, the pure water obtained simply through air purification and condensation still cannot reach the standard of high-quality drinking water.

### BRIEF SUMMARY OF THE INVENTION

For solving the technical problems, the invention provides a water quality optimization system which can further optimize pure water obtained through air purification and condensation to make the pure water reach the standard of high-quality drinking water.

According to the technical scheme adopted by the invention for solving the technical problems, the water quality optimization system comprises a water pump, a water purification device, a water storage device, a controller, a power source and a pH value regulation device, wherein an inlet of the water pump is connected with a water source, an outlet of the water pump is connected with the pH value regulation device; the pH value regulation device is connected with the water storage device through the water purification device, and the water storage device is connected with a system outlet and further connected with the inlet of the water pump through valves; the water storage device comprises a pH value detector, the signal output end of the pH value detector is connected with the controller, and the control ends of the valves and the control end of a water pump driving circuit are all connected with the controller.

According to the water quality optimization system, the valves are electromagnetic valves, and the water storage device comprises a plurality of water receivers. The water receivers are connected with the inlet of the water pump through the corresponding electromagnetic valves respectively.

According to the water quality optimization system, the water purification device comprises a filter, a water electrolysis device, a reverse osmosis (RO) device, an RO rear active carbon filter device and an ultraviolet sterilization device.

According to the water quality optimization system, the filter, the water electrolysis device, the reverse osmosis (RO) device, the RO rear active carbon filter device and the ultraviolet sterilization device are sequentially connected in series, the filter is connected with the pH value regulation device, and the ultraviolet sterilization device is connected with the water storage device.

The water quality optimization system further comprises a water magnetization device, and the water storage device is connected with the system outlet through the water magnetization device.

According to the water quality optimization system, the power source is a solar power source.

The water quality optimization system of the invention can further optimize pure water obtained through air purification and condensation to make the pure water reach the standard of high-quality drinking water.

### BRIEF DESCRIPTION OF THE SEVERAL VIEWS OF THE DRAWINGS

A further detailed description of the invention is given with the accompanying drawing and the specific execution mode as follows.

The FIGURE is a system chart of a water quality optimization system of an embodiment of the invention.

### DETAILED DESCRIPTION OF THE INVENTION

As is shown in the FIGURE, a water quality optimization system of the invention comprises a high-pressure water pump, a water purification device, a water storage device, a controller, a solar power source, a pH value regulation device and a water magnetization device.

The water purification device comprises a filter, a water electrolysis device, a reverse osmosis (RO) device, an RO rear active carbon filter device and an ultraviolet sterilization device.

The filter, the water electrolysis device, the reverse osmosis (RO) device, the RO rear active carbon filter device and the ultraviolet sterilization device are sequentially connected in series, the filter is connected with the pH value regulation device, and the ultraviolet sterilization device is connected with the water storage device.

An inlet of the high-pressure water pump is connected with a pure water source, an outlet of the high-pressure water pump is connected with the pH value regulation device, the pH value regulation device is connected with the water storage device through the water purification device, and the water storage device is connected with a system outlet through the water magnetization device and further connected with the inlet of the high-pressure pump through valves; the water storage device comprises a pH value detector, the signal output end of the pH value detector is connected with the controller, and the control ends of the valves and the control end of a high-pressure water pump driving circuit are all connected with the controller.

The valves are electromagnetic valves, and the water storage device comprises a plurality of water receivers. The water receivers are connected with the inlet of the high-pressure water pump through the corresponding electromagnetic valves respectively.

According to the embodiment of the invention, the pH value of pure water provided by the water source is detected and then balanced and regulated, no additive is added during the balancing and regulating process, the water is electrolyzed and balanced into acid water or alkaline water by an electrolysis method according to the pH value of the water, and the system can further regulate the pure water into alkalescent water for drinking and make the water reach the standard of optimal drinking water.

Certain impurities can be generated after the pH value of the pure water is balanced and need to be isolated and removed through the filter device, the pure water then enters a water softening device of the water electrolysis device and is changed into soft water by reducing the hardness of the water to 70 mg/l or below according to the ion exchange principle, namely by exchanging Mg²⁺Ca²⁺ with Na⁺, and thus the pure water is optimized.

The optimized pure water is comprehensively filtered (such as impurities and heavy metal) and sterilized through the reverse osmosis (RO) device and enters the water storage device after passing through the active carbon filter device and the stainless steel high-energy ultraviolet sterilization device.

The water storage device starts a circulating device to activate the pure water according to the pH value and storage time of water in each water tank, and the specific process is as follows: the pH value is monitored through the pH value detector in the water storage device, if it is found that the pH value of water in a certain pure water tank does not meet the standard, an alarm can be given to the controller of the system and be synchronized into a master monitoring system of a central control room, the controller starts the high-pressure water pump and opens the corresponding electromagnetic valve, pure water in the water tank not meeting the pH value standard is circulated, and thus the pure water can be balanced circularly. Meanwhile, the storage time of water in each tank is recorded and stored in the controller and a master control system of the central control room, if the pure water in a certain water tank is not utilized in a set period of time, the master control system of the central control room can give out a command to the circulating system, and the pure water in the tank is activated circularly.

Finally, the water storage device supplies water to the magnetization device according to the production requirement, and then the water is supplied to an automatic bottled water production system to be bottled and packaged.

What is claimed is:

1. A water quality optimization system, comprising a water pump, a water purification device, a water storage device, a controller and a power source, characterized by further comprising a pH value regulation device, wherein an inlet of the water pump is connected with a water source, and an outlet of the water pump is connected with the pH value regulation device; the pH value regulation device is connected with the water storage device through the water purification device, and the water storage device is connected with a system outlet and further connected with the inlet of the water pump through valves; the water storage device comprises a pH value detector, the signal outlet end of the pH value detector is connected with the controller, and the control ends of the valves and the control end of a water pump driving circuit are all connected with the controller.

2. The water quality optimization system according to claim 1, characterized in that the valves are electromagnetic valves, the water storage device comprises a plurality of water receivers, and the water receivers are connected with the inlet of the water pump through the corresponding electromagnetic valves respectively.

3. The water quality optimization system according to claim 1, characterized in that the water purification device comprises a filter, a water electrolysis device, a reverse osmosis (RO) device, an RO rear active carbon filter device and an ultraviolet sterilization device.

4. The water quality optimization system according to claim 3, characterized in that the filter, the water electrolysis device, the reverse osmosis (RO) device, the RO rear active carbon filter device and the ultraviolet sterilization device are sequentially connected in series, the filter is connected with the pH value regulation device, and the ultraviolet sterilization device is connected with the water storage device.

5. The water quality optimization system according to claim 1, characterized by further comprising a water magnetization device, wherein the water storage device is connected with the system outlet through the water magnetization device.

6. The water quality optimization system according to claim 1, characterized in that the power source is a solar power source.
